(19) United States
(12) Patent Application Publication
(10) Pub. No.: US 2011/0131584 A1
(43) Pub. Date: Jun. 2, 2011

(54) THE METHOD AND APPARATUS FOR THE RESOURCE SHARING BETWEEN USER DEVICES IN COMPUTER NETWORK

(76) Inventors: Xu Wang, Shanghai (CN); Fang Liu, Shanghai (CN)

(21) Appl. No.: 13/056,179

(22) PCT Filed: Jul. 29, 2008
(86) PCT No.: PCT/CN08/01386

§ 371 Date: Jan. 27, 2011

(51) Int. Cl. G06F 9/50

(52) U.S. Cl. 718/104

(57) ABSTRACT

To solve the problems in prior art, the present invention has provided a new scheme for resource sharing between user devices, which shall be easily used, implemented and extended. Also, the present invention aims to decrease the user input for resource sharing. In particular, the present invention is based on IM protocol, the sharing initiator, and its cooperators concerning the key information of the to-be-consigned tasks via IM messages. Then, preferably, the initiator chooses one or more cooperators for each of the to-be-consigned tasks after further communication with the cooperators. For each task, the chosen cooperators will be referred to as its nominated cooperators. At last, each of the cooperators will handle the task(s) consigned to it, if any, and sends the result back to the initiator.

### TECHNICAL FIELD

The present invention relates to the resource sharing in computer network, particularly, to the method and apparatus for resource sharing based on Instant Messaging (IM) protocol between user devices in computer network.

### BACKGROUND

The rapid development of Internet has provided people with more chances for sharing resources. The existing technologies for the resource sharing between different user devices (e.g., PC and notebook) are as follows:

Traditional RPC Protocol and CORBA Protocol

RPC (Remote Program Calls) is a kind of technique by which users can access to remote computer resources and need not to know the protocols of under-layer network technology. Meanwhile, CORBA is a distribution technique on an equal footing with COM, JAVA. CORBA provides a distribution framework based on positions and protocols, that is, the user must be bound with the position of the service in advance and possess relevant ORB database to have communication by means of HOP. For more details, please see the website: http://www.corba.org.

RPC and CORBA provide users with a way of accessing to remote computer resources. However, these protocols require a user at the level of a programmer (e.g. java programming), and the programmer needs to know the detailed programming interfaces, resources capacities information, etc. before programming. Hence, these protocols are not quite popular.

A Mobile Agent (MA)

MA is a program which can decide on its own and move among nodes to undertake certain task. Actually, it is a network computation, which can choose its running place and time, interrupt its execution according to specific situations, move toward another computer for recovery and send relevant results back in time by itself.

Unfortunately, MA relies on the movement of codes between different computers, which may inevitably cause serious security problems. The reasons are as follows: 1) the codes may be intercepted when moving from one computer to another; 2) during the process of movement they may be tampered and cause the damage to the software and operation system of another computer.

Please refer to http://en.wikipedia.org/wiki/Mobile_agent for details.

Grid Computing

Gird computing establishes a framework, in which distributed computation and resources sharing are conducted among heterogeneous systems. However, this framework requires a virtual super computer to combine and manage resources, so the under-layer grid system is quite complicated and users have to follow the specific instructions of its program design.

Please refer to http://www.globus.org/tookit/draft-ggf-ogsi-gridservice-33_{—}2003-06-27.pdf for details concerning grid computing.

Web-Based Consignment Services

Currently, there are some web-based consignment services on the Internet. For example, the services of converting various types of original files to files in PDF format have been offered on the website (http://www.expresspdf.com). FIG. 1 shows the webpage about the service of converting .DOC documents to .PDF ones. Wherein, a user can click button B1 “Browse” to activate a dialog box, wherein, he or she is allowed to select a .DOC document stored on a local memorizer or on an accessible network memorizer. Further, in order to send the corresponding .PDF documents back to the user, this webpage also comprise an input box B2, wherein, the user needs to input the E-mail address which he/she wants to use to receive the .PDF documents. After completing the aforementioned operations, the user clicks the button B3 “Convert to PDF!”; Accordingly, the selected .DOC documents will be submitted to the server of the website and be converted to .PDF format by certain software, e.g. Adobe PDF. Finally, the .PDF documents will be sent to the e-mail address chosen by the user, such as abcdef@yahoo.com.cn.

However, this solution is only based on web browser (e.g., MS internet explorer). The user also has to conduct inputting operations for many times. What's more, it only achieves the resource sharing between a single server and a single user device, and the resource sharing between user devices still cannot be achieved.

### SUMMARY OF THE INVENTION

To solve the problems above, the aim of the present invention is to provide a new scheme for resource sharing between user devices in a computer system. This scheme should have the advantages of being used easily and reducing the inputs of users to realize the automation to a greater extent. In particular, the present invention is based on IM protocols.

Hereinafter, the user device of a local user which will use the resources of other user devices will be referred to as the sharing initiator (“initiator”). And, the user devices of the buddies of this local user will be referred to as the cooperators of the initiator.

According to the present invention, the initiator informs its cooperators of the key information of the tasks ready to be consigned via IM messages. Then, preferably, the initiator chooses one or more cooperators for each to-be-consigned task by means of multi-user device interaction. For each task, the chosen cooperator(s) will be referred to as the nominated cooperator(s) in relation to the subject task ('nominated cooperator(s)'). At last, each of the cooperators will handle the task(s) consigned to it, if any, and will send the result back to the initiator.

In order to achieve the aim above, according to the first aspect of the present invention, there is provided a method for, in a computer network, sharing resources between user devices on the basis of instant messaging protocols. Wherein, a sharing initiator has a number of cooperators, the method comprises steps of: b. for each task to be consigned, the sharing initiator consigns the task to one or more nominated cooperators in relation to said task via interactive information of IM protocols; c. each nominated cooperator in relation to the task handle the task respectively; d. the nominated cooperators in relation to the task send the result back to said sharing initiator.

According to the second aspect of the present invention, there is provided the first sharing apparatus, in a user device of a computer network, for sharing the resources of other user devices based on IM protocols, wherein, the user device has a plurality of cooperators. The first sharing apparatus comprises: 1) a task consigning means for, in respect of each task to be consigned, consigning the task to one or more nominated cooperators in relation to the said task; and 2) a result receiving means for receiving the result from the cooperators in relation to the task.

According to the third aspect of the present invention, there is provided the second device for resource sharing, in a user device of a computer network, for assisting another user device to share the resources of the local user device based on IM protocols, characterized in comprising: a consignment receiving means, for receiving the consignment from another user device via interactive messages of IM protocols, the consignment indicates that the local user device is a cooperator in relation to one or more to-be-consigned tasks of said another user device and is responsible for handling the corresponding tasks; a determination assisting means, for assisting another user device to determine one or more nominated cooperators for each of its tasks to be consigned; a sub-handling means for handling one or more tasks ordered by the consignment to get the corresponding consequence; result returning means, for returning the result to said another user device.

Those skilled in this art understand that, the user device in computer network in this text shall cover all kinds of devices which can support IM protocols to communicate with other devices, comprising but not limited to: desktop personal computer (PC), notebook PC, portable digital assistant (PDA), intelligent cell phone, network server and other terminal equipments.

Those skilled in this art also understand that, the technical solution provided by this invention is applicable to the networks based on Server/Client mode (S/C) or Peer-to-Peer (P2P).

The aforesaid method and apparatus make it possible for user devices to share resources based on IM protocols. They are easily implemented and extended, and thus the professional users will not be limited by traditional methods or architectures when exploiting more powerful application procedures or services.

### BRIEF DESCRIPTION OF DRAWINGS

Other features, aspects and advantages of the present invention will become clearer by reading the following description with the aid of the drawings. Wherein:

FIG. 1 illustrates the Webpage of http://www.expresspdf.com/, which offers services of conversing .DOC documents to .PDF ones;

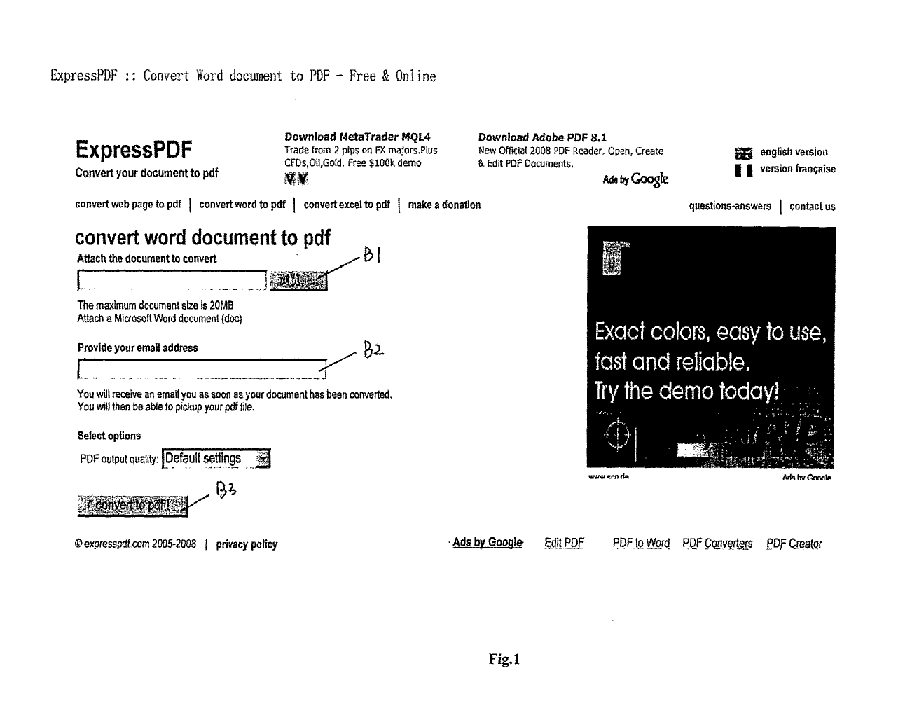

FIG. 2 shows the computer network based on IM protocols according to a preferable example of the present invention;

FIG. 3 is the flowchart of a systematic method for the resource sharing between user devices based on IM protocols in computer network according to a preferable example of the present invention;

FIG. 4 is the block diagram of the first sharing apparatus, in a user device of a computer network, for sharing the resources of other user devices based on IM protocols, according to a preferable example of the present invention;

FIG. 5 is the block diagram of the second sharing apparatus, in an user device of a computer network, for assisting another user device to share the resources of the local user device based on IM protocols, according to a preferable example of the present invention;

FIG. 6 shows the diagram of application procedures of implementing the present invention.

Wherein, same or similar reference numerals refer to the same or similar step-features or means-features.

### EMBODIMENT OF THE PRESENT INVENTION

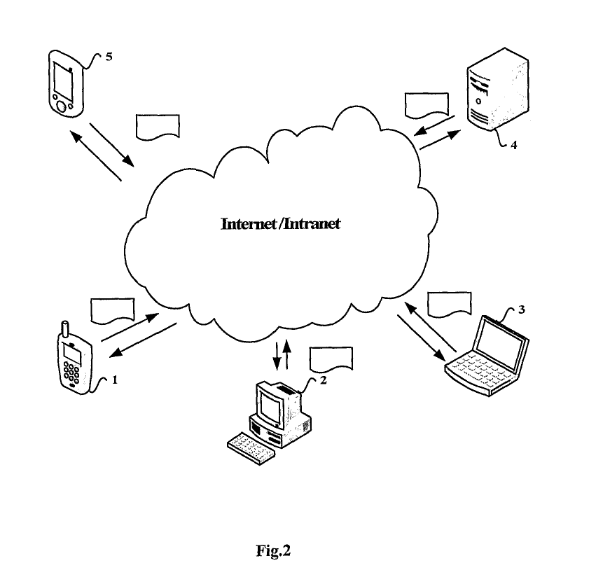

FIG. 2 shows the computer network based on IM protocols according to a preferable example of the present invention. Wherein, the network comprises user device 1 (PDA), user device 2 (Desktop PC), user device 3 (notebook PC), user device 4 (an accessible network server) and user device 5 (PDA), all of which are for communication via Internet or Intranet. To implement the present invention, certain IM software has been installed on every user device in the shown figure, such as MSN messenger, QQ, Skype. These kinds of software have a common feature, there is a buddy list maintained on the user device or on a network device provided by the service provider.

According to this example, Shane holds the user device 1, Arthas holds the user device 2, Kyle holds the user device 3, Alucard holds the user device 4, and Jennifer holds the user device 5. Wherein, Shane is the local user of the initiator, namely the user device 1, and Arthas, Kyle, Alucard and Jennifer are all buddies of Shane on MSN messenger (hereinafter referred to as ‘MSN’). Hence, user devices 2-5 are all cooperators of the user device 1.

Preferably, each user device respectively maintains its resource list. Generally speaking, this list comprises the information of the follows: CPU, Volatile Memory, Operation System, installed software and the main functions of the installed software. Optionally, one or more items of the aforesaid information can be stored on a central or several distributed database-like network server(s), and can be updated by the corresponding user device for the purpose of the access of other user devices. According to a special example of the present invention, such information as CPU, Volatile Memory, OS, installed software and their functions all can be stored on such database-like network servers. The stored information certainly should be accessible, and each user device is responsible for updating its information and making other users access to and read it. The functions of the aforesaid lists of resources information will be explained in detail in the following context.

Those skilled in this art understand that the computation ability of CPU and the buffering ability of volatile Memory usually play an important role in the calculating speed of a user device. If these resources (CPU, Volatile Memory, etc) are quite limited compared with the requirements of the task(s), they may be exhausted. Those skilled in this art also understand that, storing ability of a user device may restrict the number and size of software that can be installed thereon, especially the software occupying more memory space.

Different user devices may have different resource status. Take the user device 1 (a PDA) for an example. Due to the limitation of its dimension, the frequency of its CPU may range from 400 MHZ to 600 MHZ and the Volatile Memory may be 64 MB or 128 MB, which is negligible when comparing with the leading PC or notebook. On the other side, the disadvantage of memory capability with respect to PDA Non-Volatile Memory may be acceptable. However, a large quantity of powerful software requires huge storage space, thus it will put pressure on PDA which mainly relies on memory cards such as SD, CF, MS-PRO, MS-DUO.

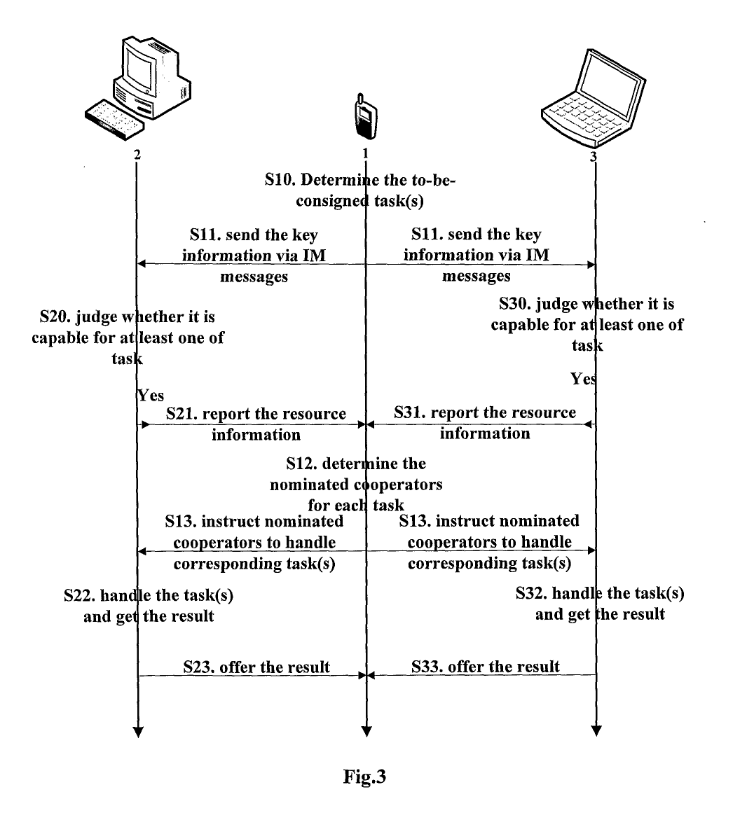

Based on the above analysis, a preferable example of the present invention will be described in combination with the flowcharts. Please see FIG. 3, the systematic flowchart of a method for the resource sharing between user devices based on IM protocols in computer network according to a preferable example of the present invention. The preferable example will be described with reference to FIG. 3 and in conjunction with FIG. 2.

Shane downloads a movie in AVI format by the user device 1, coded by H.264 standard. However, the user device 1 can only play videos in MPEG4 format, and can not play videos based on H.264. Hence, this movie has to be converted into MPEG4 format before being played on the user device 1. According to one example of the present invention, the user device 1 has no installed software for the conversion from H.264 to MPEG4. At that moment, Shane clicks a button on the touch screen to show that he wants to watch this video. Since the format thereof can not be supported by the player on the user device 1, there are the following circumstances:
the player on the user device 1 is started, but it fails to recognize the file type of the AVI video;
the player on the user device 1 is not started, and Shane is reminded of selecting another software to open it.

According to the configuration in practice, the present method can flexibly enter S10 as shown in the figure at certain moment, e.g., when the player is started and cannot recognize the file type, or when it reminds Shane of selecting other software.

Now, a format conversion is necessary for watching the video in AVI format. Then in S10, the user device 1 determines that many video frames of the file need to be converted from H.264 to MPEG4. Certainly, the number of tasks can be determined flexibly. For example, the conversion of the AVI file as a whole can be defined as a single task, or, the conversion of every single frame can be defied as a task, or, the conversion of a set of frames can be such a task. In this example, the user device 1 divides the AVI file into 10 equal parts. Consequently, there are 10 tasks, each of which corresponds to the conversion of a plurality of frames. Specially, one of them also corresponds to the conversion of the AVI header to MPEG4 header to ensure that the player at the user device 1 can work when playing the converted file.

When 10 tasks have been determined, the method enters S11.

In S11, the user device 1 will send the key information of the ten tasks, via MSN messages, to its cooperators, saying, the user devices of Jennifer Alucard, Kyle and Arthas. The key information can be in the form of XML, e.g.:

<task type>File Conversion</task type>
<input>H.264<input>
<output><MPEG4></output>
<input data>...</input data>

Wherein, the first line denotes that the type of the task is file conversion; the second line denotes that the original format of the file is H.264; the third line denotes that the desired format is MPEG4. And the fourth line stands for the original data to be converted. Those skilled in this art understand, if the size of data to be consigned for conversion is not large, the original data can be directly sent to the cooperators as shown above when key information is sent. In this example, since the conversed data has a size of 10M or even 100M, preferably, the fourth line ‘<input data> . . . </input data> can only stand for the size of data corresponding to each task. The specific data can be sent to the cooperators after the nominated cooperator(s) in relation to each task have been determined. Certainly, if the network transmission resources are quite sufficient, the user device 1 can send the to-be-converted file(s) to every cooperator when providing key information thereof. Under such a scenario, when consigning task(s) later, the user device 1 only needs to tell each nominated cooperator that which task(s) it has been consigned with.

Now, if MSN is not running on the user device 1, this software will be started first, and then conduct the logging in or something like that. This stands for a preferable example of the invention, wherein, even though MSN can support to send off-line messages as well, in S11, the user device 1 sends key information of the tasks only to the user devices of Shane's online buddies. Certainly, if the tasks are not urgent, the user device 1 can send the key information to the user devices of all Shane's MSN buddies, and the nominated cooperators of each task can be determined after the user device 1 has obtained the resource information of the user devices of all Shane's buddies (comprising the ones online and offline) when performing S11. Concisely, only user devices 2 and 3 are shown in FIG. 3 as cooperators of the user device 1.

Then, this method enters optional and preferable steps S20/S30 at user devices 2 and 3 respectively. Wherein, after obtaining the key information of ten to-be-consigned tasks of the user device 1, user devices 2 and 3 respectively check their own resource information. In detail, they can, by accessing to the resource information list maintained by itself or by a network server, know whether they have such software that can convert an H.264 file into MPEG4 and also obtain the information of the OS, CPU frequency, Volatile Memory size, etc. Based on the above information, user devices 2 and 3 will respectively decide whether they are capable of handling one or more of ten tasks.

In this example, said software for the conversion has been installed on both user devices 2 and 3. What's more, each of user devices 2 and 3 judges that it is capable for at least one of the tasks based on past experience. For example, the information of the occupied CPU, Volatile Memory was kept when such devices performed the similar video conversion before. Preferably, both user devices 2 and 3 do this judgment based on their status of current resource occupation because a device with higher CPU frequency and larger Volatile Memory may have worse performance than a device with lower CPU frequency and smaller Volatile Memory, in case that the CPU and Volatile Memory of the former is occupied badly.

In case that both user devices 2 and 3 get a judgment ‘Yes’ in S20 and 30 respectively, they will inform the user device 1 of their resource information separately. Preferably, the reported resource information is in relation with OS version, CPU frequency, Volatile Memory size, software version of the reporting device.

Wherein, the resource information from user device 2 can be:

<cpu>2.0G AMD Atholon</cpu>
<Volatile Memory>512M</Volatile Memory>
<operation system>Windows XP Home Edition</operation system>
<application>MPEG4 Convertor</application>
<version>1.0</version>

and the resource information from user device 3 can be:

<cpu>3.0G Pentium 4</cpu>
<Volatile Memory>1.0G</Volatile Memory>
<operation system>Windows XP Home Edition</operation system>
<application>MPEG4 Convertor</application>
<version>1.0</version>

What is preferred, the resource information send from cooperators to the sharing initiator comprises not only the total number of resources, e.g. CPU frequency, Volatile Memory size, but the occupation status thereof, e.g. the occupied percentage of CPU, Volatile Memory, etc. The resource information provided in this preferable example can be:

<cpu>3.0G Pentium 4</cpu>
<cpu occupied> 33% </cpu occupied>
<Volatile Memory>1.0G</Volatile Memory>
<Volatile Memory occupied> 33% </cpu occupied>
<operation system>Windows XP Home Edition</operation system>
<application>MPEG4 Convertor</application>
<version>1.0</version>

For conciseness, the feedback of such tasks from user devices 4, 5 are not shown in the flow chart. And, in this example, user device 5 does not install the conversion software. Or, user device 5 estimates that such conversion will lead to the exhaustion of its resources because too many resources are occupied or it will take quite a long time to handle one task. Hence, user device 5 gives up handling any task, and may not respond to the user device 1. Besides, user device 4, a server, is now under a heavy burden, and the CPU and Volatile Memory thereof are highly occupied (maybe 90% or above), hence user device 4 also gives up handling any task.

Therefore, after S21 and 31, the resource information collected by the user device 1 will comprise only the relevant information of the CPU, Volatile Memory, OS, and video conversion software of user devices 2, 3.

Then, in S12, the user device 1 determines the nominated cooperator(s) for each of the 10 tasks. A simple way is that the user device 1 distributes the 10 tasks according to the CPU frequencies of the cooperators. According to this rule, six tasks among ten will be allocated to user device 3, and other four tasks will be allocated to user device 2. In a more complicated situation, each item of CPU frequency, Volatile Memory size and OS of each cooperator will be weighted by a predetermined parameter, and the result can represent the capability of the cooperator(s) roundly. And the nominated cooperators will be determined based on such result.

Hence, in S13, the user device 1 will inform the nominated cooperators of the task(s) consigned. Specifically, the user device 1 sends the whole AVI file to user devices 2 and 3 via MSN, and orders them to convert a certain part at different moments thereof. Alternatively, the user device 1 can also divide the AVI file in advance, that's to say, dividing the file into two parts, one corresponding to six tasks and the other corresponding to four tasks. The two parts will be sent to the destination accordingly.

The consignment methods of detailed tasks can include:

Solution 1: Adding new format of instructions, and extending the existing IM software to support the new instructions;

Solution 2: Adding new instructions into the existing IM messages.

Then, in S22 and S32, user devices 2 and 3 run the installed MPEG4 Convertor, and fulfill the tasks instructed by the user device 1 in S13.

In S23, S33, user devices 2 and 3 send the converted MPEG4 data back to the user device 1. The data can be in form of

<task type> File Conversion </task type>
<input> AVI </input>
<output> MPEG4 </output>
<output data>...</output data>

Of course, the MPEG4 data sent back by the user devices 2 and 3 can be transmitted by any network transmission manner, comprising but not limited to: using the packing tools provided by MSN to encapsulate the MPEG4 data and sending the package via MSN messages. At that time, the user device 1 can automatically store the data at a preset position on its hard disk.

Certainly, in case that the user device 1 is unable to combine two parts of MPEG4 data to get a playable MPEG4 file, it is required that the two MPEG4 segments sent back by user devices 2 and 3 should be both readable and playable at the user device 1. Hence, user devices 2 and 3 should generate file headers for their converted data respectively. Consequently, the AVI file becomes two separate MPEG4 files when sent back to the user device 1. Alternatively, when the user device 1 is unable to combine two MPEG4 segments, in S12, the user device 1 can only choose one user device owning the best capability, namely the user device 3, to handle ten tasks.

In the above paragraphs, we discussed about the situation that the user device 1 does not install the software of conversion (AVI→MPEG4). According to another example of the invention, there is such kind of software installed on the user device 1. Hence, when Shane attempts to enjoy the AVI file but fails, the user device 1 will realize that a conversion is necessary. It judges whether the conversion is beyond its capability if the conversion is performed only by itself according to its CPU, Volatile Memory, OS, etc. For example, the user device 1 reads the historical data, which can help it to learn to what extent its CPU, Volatile Memory will be occupied and how long it will take, if the user device 1 handles the conversion by itself. Based on the aforesaid information, the user device 1 can tell whether the estimated occupation ratios and time length are acceptable. Generally, this judgment can be done with the aid of a CPU occupation ratio threshold, a Volatile Memory occupation ratio threshold, a time length threshold, etc. Once one of the aforesaid indexes goes beyond the corresponding thresholds, the user device 1 will consign the conversion of the whole AVI file or a part hereof to its cooperators.

Alternatively, the user device 1 can do a preliminary conversion of the AVI file. That's to say, the user device 1 performs a moment conversion of a tiny segment of the AVI file. The aim of this moment conversion is not to get the corresponding MPEG4 segment, but to obtain information as follow: the occupation ratios of CPU and Volatile Memory, and the time needed if the user device 1 conducts the conversion solely. Then, the information will be compared with the corresponding thresholds to determine whether the conversion should be consigned wholly or partially.

In this example, the user device 1 learns the resource status of its cooperators based on the reports from them. According to an example of the invention, the user device 1 determined the nominated cooperator(s) of each task according to the total resources of user devices 2-5 rather than the resources available. Since the change of the total number of resources (e.g., CPU frequency, Volatile Memory size) of a user device may be infrequent, S11, S20, S30, S21 and S31 are all optional. Then, the relevant resource information of other user devices obtained by the user device 1 before can help to determine the nominated cooperators this time. Those skilled in this art understand that if the user device 1 chooses the nominated cooperator(s) of each to-be-consigned task on the basis of the available resources (e.g., CPU left, free Volatile Memory) of its cooperators, this method comprises the aforesaid optional steps S11, S20, S30, S21 and S31 to make the user device 1 know the resource information of the cooperators timely.

According to a variation of the prior example, the nominated cooperator(s) of each task can also be determined via the exchange between the cooperators of the user device 1. Referring to FIG. 2, when the user device 1 tells user devices 2-5 about the key information of the tasks, each of user devices 2-5 lets other three know its resource information with the aid of the user device 1. Then, anyone of user devices 2-5 can determine the nominated cooperator(s) for each task, and informs others of the result.

In the above paragraphs, the present invention is described by taking video conversion as an example. Those skilled in this art understand that, the present invention is not limited to the particular examples, and can be applied to any scenario in which a device of a computer network needs resource sharing. The shared resources comprise but not limited to application, software running environment, the capability of hardware, etc, e.g., the conversion from .DOC to .PDF, complicated matrix computation or image processing in Matlab.

According to a special example of the present invention, all cooperators of the initiator are default nominated cooperators of each to-be-consigned task. Hence, steps S11, S20, S30, S21, S31, and S12 are all optional. When 10 tasks are determined in S10, the method enters S13, wherein, the user device 1 consigns all 10 tasks to every cooperator (user devices 2-5). Then, every said cooperator tries to handle the aforesaid tasks and sends the result back to the user device 1.

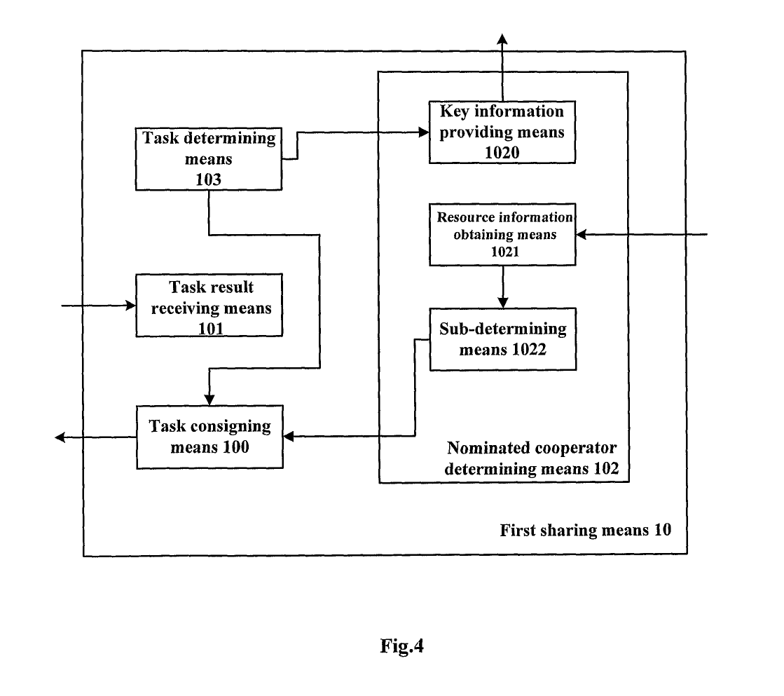

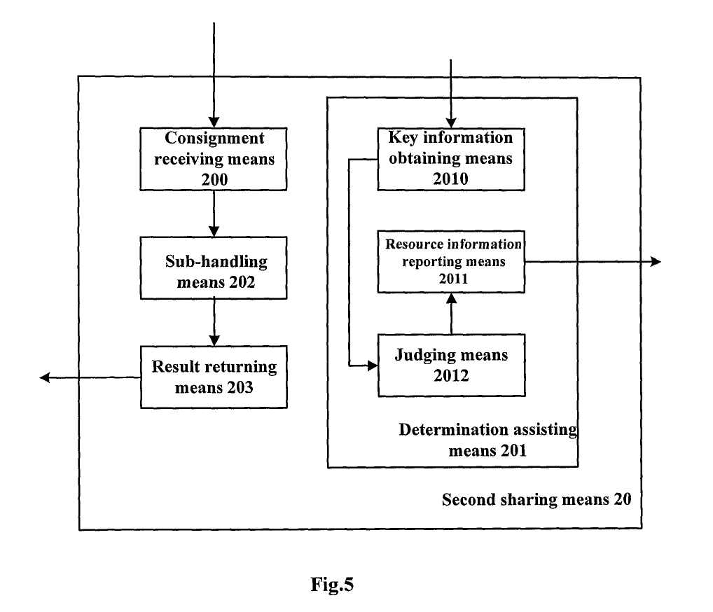

We describe the present invention based on methods above. Hereinafter, the present invention will be described referring to the block diagrams. Wherein, FIG. 4 is the block diagram of the first sharing apparatus, in a user device of a computer network, for sharing the resources of other user devices based on IM protocols, according to a preferable example of the present invention. FIG. 5 is the block diagram of the second sharing apparatus, in a user device of a computer network, for assisting another user device to share the resources of the local user device based on IM protocols, according to a preferable example of the present invention.

Those skilled in this art understand, in practice, a user device can comprise the first sharing apparatus 10 and the second sharing apparatus 20, or only one of them. In some particular situations, e.g. the resources of a user device is always insufficient, thus it may be always asking for help (acting as a sharing initiator); or the resources of a user device are so sufficient that it never needs help from others, it may always give its resources (acting as a cooperator). In the aforesaid particular situations, a user device may comprise only one of the aforesaid devices. Generally, a user device is configured with both of the two.

To be more detailed, the first sharing apparatus 10 comprises: a task consigning means 100, a task result receiving means 101, nominated cooperator determining means 102 and task determining means 103. Further, the nominated cooperator determining means 102 comprises a key information providing means 1020, a resource information obtaining means 1021 and a sub-determining means 1022.

The second sharing apparatus 20 comprises: a consignment receiving means 200, determination assisting means 201, sub-handling means 202 and result returning means 203. Further, determination assisting means 201 comprises key information obtaining means 2010, resource information reporting means 2011 and judging means 2012.

For example, the user device 1 in FIG. 2 asks its cooperators for help. Shane downloads a movie in AVI format by the user device 1, coded by H.264 standard. However, the user device 1 can only play MPEG4 videos, and can not play video files based on H.264. Hence, this movie has to be converted to MPEG4 format before being played on the user device 1. In one example of the present invention, the user device 1 has no installed software for the conversion from H.264 to MPEG4. Now, Shane clicks a button on the touch screen to show that he wants to watch this video. Since the format thereof cannot be supported by the player on the user device 1, there are the following circumstances:
the player on the user device 1 is started, but it fails to recognize the file type of the AVI video;
the player on the user device 1 is not started, and Shane is reminded of selecting another software to open it.

According to the configuration in practice, task determining means 103 in the first sharing apparatus 10 can start to work at certain moment, e.g., when the player is started and can not recognize the file type, or when it reminds Shane of selecting other software.

Now, a format conversion is necessary for watching the video in AVI format. Then task determining means 103 at the user device 1 determines that a large number of video frames of the file need to be converted from H.264 to MPEG4. Certainly, the number of tasks can be determined flexibly. For example, the conversion of the AVI file as a whole can be defined as a task, or, the conversion of every single frame can be defined as a task, or, the conversion of a set of frames can be such a task. In this example, the user device 1 divides the AVI file into 10 equal parts. Consequently, there are 10 tasks, each of which corresponds to the conversion of a plurality of frames. Specially, one of them tasks also corresponds to the conversion of the AVI header to MPEG4 header to ensure that the player at the user device 1 can work when playing the converted file. Task determining means 103 then informs key information providing means 1020 of the determined 10 tasks.

Then, key information providing means 1020 sends the key information of the 10 tasks, via MSN messages, to the cooperators of the user device 1. The key information can be in the form of XML, e.g.:

<task type>File Conversion</task type>
<input>H.264</input>
<output><MPEG4></output>
<input data>...</input data>

Wherein, the first line denotes that the type of the task is file conversion; the second line denotes that the original format of the file is 11.264; the third line denotes that the desired format is MPEG4. And the fourth line stands for the original data to be converted. Those skilled in this art understand, if the size of data to be consigned for conversion is not large, the original data can be directly sent to the cooperators as shown above when key information is sent. In this example, since the data to be converted has a size of 10M or even 100M, preferably, the fourth line ‘<input data> . . . </input data> can only stand for the size of data corresponding to each task. The specific data can be sent to the cooperators after the nominated cooperator(s) in relation to each task have been determined. Certainly, if the network transmission resources are quite sufficient, the user device 1 can send the to-be-converted file(s) to every buddy. Under such a scenario, when consigning task later, the user device 1 only needs to tell each nominated cooperator that which task(s) it has been consigned with.

Now, if MSN is not running on the user device 1, key information providing means 1020 runs this software first, and then the logging in or something like that. This stands for a preferable example of the invention, wherein, though MSN can support off-line messages, key information providing means at the user device 1 sends key information of the tasks only to the user devices of Shane's online buddies. Certainly, if the tasks are not urgent, the user device 1 can send the key information to the user devices of all Shane's buddies on MSN, and the nominated cooperators of each task can be determined after the user device 1 has obtained the resource information of the user devices of all Shane's buddies (comprising the ones online and offline). Concisely, only user devices 2 and 3 are shown in FIG. 3 as cooperators of the user device 1.

Then, key information obtaining means 2010 at user devices 2 and 3 will receive the key information respectively, and then give it to the judging means 2012. Wherein, after each judging means 2012 at user devices 2 and 3 learn the key information of the 10 to-be-consigned tasks of the user device 1, it checks the resource information of the local user device. Specifically, judging means 2012 at each of user devices 2 and 3 can, by accessing to the resource information list maintained by the user devices themselves or by a network server, know whether is the user devices have such software that can convert an H.264 file to MPEG4 and also obtain the information of OS, CPU frequency, Volatile Memory size of the local user device, etc. Based on the information above, judging means 2012 at each of user devices 2 and 3 will respectively decide whether the local user device is capable of handling one or more of the 10 tasks.

In this example, judging means 2012 at user devices 2 and 3 judges that the said software for conversion has been installed on both user devices 2 and 3. What's more, judging means 2012 at user devices 2, 3 judges that the local user device is capable for at least one of the tasks based on past experience. For example, the information of the occupied CPU, Volatile Memory was kept when such devices performed the similar video conversion before. Preferably, judging means 2012 at devices 2 and 3 does this judgment based on the current resource occupation status of the local user device, because a device with higher CPU frequency and larger Volatile Memory may have worse performance than a device with lower CPU frequency and smaller Volatile Memory in case that the CPU and Volatile Memory of the former may be occupied badly.

In case that the judging means 2012 at user device 2 and user device 3 both get a judgment ‘Yes’, each judging means 2012 will order the resource information 2011 on the corresponding cooperator to inform the user device 1 of the resource information of this cooperator. Certainly, the resource information 2011 can inform the user device 1 of the resource information whatever judgment judging means 2012 has made. Preferably, the reported resource information is in relation to OS version, CPU frequency, Volatile Memory size, software version of the corresponding cooperator.

Wherein, the resource information from user device 2 can be:

<cpu>2.0G AMD Atholon</cpu>
<Volatile Memory>512M</Volatile Memory>
<operation system>Windows XP Home Edition</operation system>
<application>MPEG4 Convertor</application>
<version>1.0</version>

and the resource information from user device 3 can be:

<cpu>3.0G Pentium 4</epu>
<Volatile Memory>1.0G</Volatile Memory>
<operation system>Windows XP Home Edition</operation system>
<application>MPEG4 Convertor</application>
<version>1.0</version>

What is preferred, the resource information send from cooperators to the sharing initiator comprises not only the total number of resources, e.g. CPU frequency, Volatile Memory size, but the occupation status thereof e.g., the occupied percentage of CPU, Volatile Memory, etc. The resource information provided in this preferable example can be:

<cpu> 3.0G Pentium 4</cpu>
<cpu occupied> 33% </cpu occupied>
<Volatile Memory>1.0G</Volatile Memory>
<Volatile Memory occupied> 33% </cpu occupied>
<operation system>Windows XP Home Edition</operation system>
<application>MPEG4 Convertor</application>
<version>1.0</version>

For conciseness, the feedback from user devices 4, 5 are not shown in the flow chart. And, in this example, user device 5 does not install the conversion software. Or, user device 5 estimates that such conversion will cause the exhaustion of its resources because too many resources are occupied or it will take quite a long time to handle one task. Hence, user device 5 gives up handling any task, and may not respond to the user device 1. Besides, user device 4, a server, is now under a heavy burden, and the CPUand Volatile Memory thereof are highly occupied (maybe 90% or above), hence user device 4 also gives up any task.

Therefore, the resource information collected by the resource information obtaining means 1021 at the user device 1 will comprise only the relevant information of the CPU, Volatile Memory, OS, and video conversion software of user devices 2 and 3.

Then, sub-determining means 1022 at the user device 1 determines the nominated cooperator(s) for each one of the 10 tasks. A simple way is that sub-determining means 1022 at the user device 1 distributes the 10 tasks according to the CPU frequencies of the cooperators. According to this rule, six tasks among ten will be allocated to user device 3, and other four tasks will be allocated to user device 2. In a more complicated situation, each item of CPU frequency, Volatile Memory size and OS of each cooperator will be weighted by a predetermined parameter, and the result can represent the capability of the cooperator(s) roundly. And the nominated cooperators will be determined based on such result.

Hence, sub-determining means 1022 at the user device 1 will tell the result to the task consigning means 100, and then consigning means 100 will inform the nominated cooperators of the task(s) consigned. The task(s) will be received by consignment receiving means 200 at each of user devices 2 and 3. Specifically, the task consigning means 100 at the user device 1 sends the whole AVI file to user devices 2 and 3 via MSN, and orders them to convert a certain part thereof. Alternatively, the user device 1 can also divide the AVI file in advance, that's to say, dividing the file into two parts, one corresponding to six tasks and the other corresponding to four tasks. The two parts will be sent to the destination accordingly.

The consignment methods of detailed tasks can include:

Solution 1: Adding new format of instructions, and extending the existing IM software to support the new instructions;

Solution 2: Adding new instructions to the existing messages.

Then, sub-handling means 202 at each of user devices 2 and 3 run the MPEG4 Convertor installed on the local user device, and fulfill the tasks instructed by the user device 1 in S13.

Then, the result returning means 203 at each of user devices 2 and 3 sends the converted MPEG4 data back to the user device 1. The data can be in form of

<task type> File Conversion </task type>
<input> AVI </input>
<output> MPEG4 </output>
<output data>...</output data>

Of course, the MPEG4 data sent back by result returning means 203 at each of user devices 2 and 3 can be transmitted by any network transmission manner, comprising but not limited to: using the packing tools provided by MSN to encapsulate the MPEG4 data and sending the package via MSN messages. At that time, the user device 1 can automatically store the data at a preset position on its hard disk.

Certainly, in case that the user device 1 is unable to combine two parts of MPEG4 data to get a playable MPEG4 file, it is required that the two MPEG4 segments sent back by user devices 2 and 3 should be both readable and playable at the user device 1. Hence, user devices 2 and 3 should generate file headers for their converted data respectively. Consequently, the AVI file becomes two separate MPEG4 files when sent back to the user device 1. Alternatively, when the user device 1 is unable to combine two MPEG4 segments, the sub-determining means 1022 at the user device 1 can only choose one user device owning the best capability, namely user device 3, to handle all ten tasks.

In the above paragraphs, we discussed about the situation that the user device 1 does not install the software for conversion (AVI→MPEG4). According to another example of the invention, there is such kind of software installed on the user device 1. Hence, when Shane attempts to enjoy the AVI file but fails and then the user device 1 will realize that a conversion is necessary. The task determining means 103 at the user device 1 judges whether the conversion is beyond the capability of the user device 1 if the conversion is performed only by the user device 1 according to its CPU, Volatile Memory, OS, etc. For example, the task determining means 103 reads the historical data, which can help the user device 1 to learn to what extent its CPU, Volatile Memory will be occupied and how long it will take, if the user device 1 handles the conversion all by itself. Based on the aforesaid information, the user device 1 can tell whether the estimated occupation ratios and time length are acceptable. Generally, this judgment can be done with the aid of a CPU occupation ratio threshold, a Volatile Memory occupation ratio threshold, time length threshold, etc. Once one of the aforesaid indexes goes beyond the corresponding thresholds, the user device 1 will consign the conversion of the whole AVI file or a part hereof to its cooperators.

Alternatively, task determining means 103 at the user device 1 can do a preliminary conversion of the AVI file. That's to say, the user device 1 performs a moment conversion of a tiny segment of the AVI file. The aim of this moment conversion is not to get the corresponding MPEG4 segment, but to obtain information as follow: the occupation ratios of CPU and Volatile Memory, and the time needed if the user device 1 conducts the conversion solely. Then, the information will be compared with the corresponding thresholds to determine whether the conversion should be consigned wholly or partially.

In this example, resource information obtaining means 1021 at the user device 1 learns the resource status of its cooperators based on the reports from them. According to an example of the invention, the user device 1 determined the nominated cooperator(s) of each task according to the total resources of user devices 2-5, rather than the resources available. Since the change of the total number of resources (e.g., CPU frequency, Volatile Memory size) of a user device may be infrequent, key information providing means 1020 and determination assisting means 201 are optional. Then, the resource information of other user devices obtained by sub-determining means 1022 at the user device 1 before can help to determine the nominated cooperators this time. Those skilled in this art understand that if sub-determining means 1022 at the user device 1 chooses the nominated cooperator(s) of each to-be consigned task on the basis of the available resources (e.g., CPU left, free volatile Memory) of its cooperators, the key information providing means 1020 and the determination assisting means 201 will be preferably necessary to make the user device 1 know the resource information of the cooperators timely.

According to a variation of the prior example, the nominated cooperator(s) can also be determined via the exchange between the cooperators of the user device 1. Referring to FIG. 2, when the user device 1 tells user devices 2-5 about the key information of the tasks, each of user devices 2-5 makes other three know its resource information with the aid of the user device 1. Then, anyone of user devices 2-5 can determine the nominated cooperator(s) for each task, and informs others of the result.

According to a special example of the present invention, all online cooperators are default nominated cooperators of every to-be-consigned task. Then, when 10 tasks are determined by sub-determining means 103 at the user device 1, they will be consigned by task consigning means 100 at the user device 1 to each cooperator (user devices 2-5). Then, sub-handling means 202 at each cooperator tries to handle the aforesaid tasks and sends the result back to the user device 1 via result returning means 202 at each cooperator.

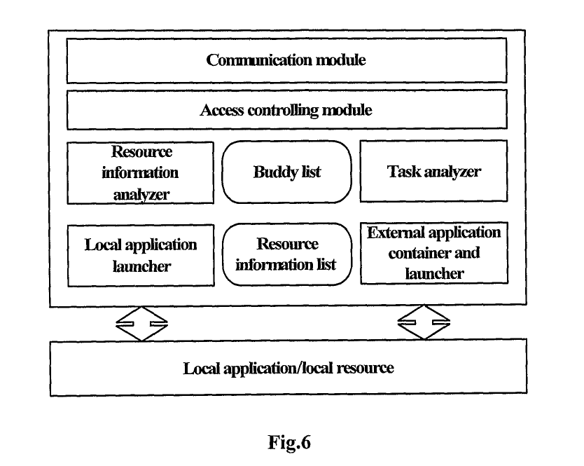

FIG. 6 shows the diagram of software for implementing the present invention. The function of the modules therein is as below:

Communication Module

For the traditional IM functions, the transport of task and result between buddies.

Access Control Module

For local application and resources access controlling; Policy enabled, can define what kind of buddies can access to the resources of the local user device at what time or to what extent.

Task Analyzer

For analyzing whether the local applications or resources can support buddies' requests through a resource information analyzer, or can pack users' requests into a task and send them to buddies through communication module.

Resources Information Analyzer

Combine the information obtained from local system with that obtained from the resource information list, to check whether the local environment can support buddies' request or not.

Local Application Launcher

For launching local application and application data transfer.

External Application Container and Launcher

It is used for storing and launching external applications from buddies and application data transfer. It can launch buddies' applications automatically or upon receipt of the buddies' start-to-action signal through XML format instruction.

Furthermore, FIG. 6 also shows local application procedures, system resources, resource information list and buddy list, in relation to the present invention.

1. A method, in a computer network, for, based on instant messaging protocols, sharing resources between user devices, wherein, a sharing initiator has a plurality of cooperators, the method comprises the following steps of:
b. for each task to be consigned, the sharing initiator consigns the task to one or more nominated cooperators in relation to the said task via IM messages;
c. the nominated cooperators in relation to the task handle the task;
d. the nominated cooperators in relation to the task send the result back to said sharing initiator.

2. The method according to the claim 1, wherein, before step b, the method further comprises a step of:
a. said sharing initiator determines one or more nominated cooperators for the task;
step b further comprises:
said sharing initiator consigns the task to the one or more nominated cooperators in relation to the said task via IM messages.

3. The method according to claim 2, wherein step a further comprises:
a1. said sharing initiator obtains the resource information of each cooperator;
a2. according to the obtained resource information of each cooperator, said sharing initiator determines one or more nominated cooperators for the task.

4. The method according to claim 3, wherein Step a1 further comprises:
a11. said sharing initiator informs the cooperators of the key information of the to-be-consigned task;
a12. the cooperators inform the sharing initiator of their resource information based on the key information of each task.

5. The method according to claim 1, wherein step a further comprises:
the cooperators negotiate with each other and determine one or more nominated cooperators for each task.

6. The method according to claim 1, wherein, before step b, the method further comprises a step of:
according to its present resource information, said sharing initiator determines one or more tasks beyond its capability and regards the said task(s) as the tasks to be consigned.

7. A first sharing apparatus, in a user device of a computer network, for sharing the resources of other user devices based on IM protocols, wherein, the user device has a plurality of cooperators, the first sharing apparatus comprises:
a task consigning means for, in respect of each task to be consigned, consigning the task to one or more nominated cooperators in relation to said task;
a result receiving means, for receiving the result from the cooperators in relation to the task.

8. The first sharing apparatus according to claim 7, further comprising:
a nominated cooperator determining means, for determining one or more nominated cooperators out of the plurality of cooperators for the task;
the task consigning means is further for, consigning the task to the determined one or more nominated cooperator(s) in relation to said task via IM messages.

9. The first sharing apparatus according to claim 8, wherein the nominated cooperator determining means further comprises:
a key information providing means, for informing the cooperators of the key information of the to-be-consigned task;
a resource information obtaining means, for obtaining the resource information of the cooperators;
a sub-determining means for, according to the key information of the task, determining one or more nominated cooperators for the task.

10. The first sharing apparatus according to claim 7, further comprising:
a task determining means for, according to the current resource information of the local user device, determining one or more tasks beyond its capability and taking the determined task(s) as the task(s) to be consigned.

11. A second sharing apparatus, in a user device of a computer network, for assisting another user device to share the resources of the local user device based on IM protocols, characterized in comprising:
a consignment receiving means, for receiving the consignment from the another user device via interactive messages of IM protocols, the consignment indicates that the local user device is a cooperator in relation to one or more to-be-consigned tasks of another user device and is responsible for handling the corresponding tasks;
a determination assisting means, for assisting another user device to determine one or more nominated cooperators for each of its tasks to be consigned;
a sub-handling means, for handling one or more tasks ordered by the consignment to get the corresponding result;
a result returning means, for returning the result to another user device.

12. The second sharing apparatus according to claim 11, wherein said determination assisting means comprises:
a key information obtaining means, for obtaining the key information of the to-be-consigned tasks of another user device;
a resource information reporting means for informing another user device of the resource information of the local user device according to the obtained key information.

13. The second sharing apparatus according to claim 12, wherein the said determination assisting means further comprises:
a judging means for, according to the key information, judging whether there is one or more tasks that the local user device is capable of;
said resource information reporting means is further for, in case that there is one or more tasks with respect to which the local user device is capable, reports the resource information of the local user device to said another user device.

14. The second sharing apparatus according to claim 12, wherein said determination assisting means is further for, negotiating with other user devices other than the local user device and said another user device, to determine one or more nominated cooperators for said task.

15. The first sharing apparatus according to claim 7 for sharing the resources of other user devices based on IM protocols wherein the first sharing apparatus is implemented in a user device in a computer network and further comprises a second sharing apparatus for assisting another user device to share the resources of the local user device based on IM protocols.
